(19) United States
(12) Patent Application Publication
(10) Pub. No.: US 2016/0154959 A1
(43) Pub. Date: Jun. 2, 2016

(54) A METHOD AND SYSTEM FOR MONITORING WEBSITE DEFACEMENTS

(71) Applicant: Banff Cyber Technoologies Pte. Ltd., Singapore (SG)

(72) Inventors: King West Matthias CHIN, Singapore (SG); Wee Ann LEE, Singapore (SG); Hwee Hong TAN, Singapore (SG)

(73) Assignee: Banff Cyber Technologies Pte. Ltd., Singapore (SG)

(21) Appl. No.: 14/906,399

(22) PCT Filed: Jul. 23, 2013
(86) PCT No.: PCT/SG2013/000303

§ 371 Date: Jan. 20, 2016

(51) Int. Cl. G06F 21/55

(52) U.S. Cl. CPC G06F 21/552; G06F 2221/034

(57) ABSTRACT

This invention relates to a method for real time communication with expression of personal emotions at the same time via instant messages and graphical representation in a simple minimised workflow. This technology enables users to easily convey their message and express their emotions at the time of conveyance of the message via instant messages more effectively as well as a more precise and accurate reflection of the users' emotions and moods at the time of communication via instant messages. This invention seeks to overcome the limitations of communication via instant messages currently whereby users are not able to convey their message and express their emotions at the time of conveyance of the message at the same time accurately and in real time.

### FIELD OF INVENTION

This invention relates generally to instant messaging and more specifically to the method of generation and presentation of graphical representations in instant messaging services.

### BACKGROUND

In this age of technological advancement, instant messaging is no doubt one of the most popular methods of relatively immediate communication between a number of people, regardless of their location, with the only requirements being availability of the instant messaging service and connectivity to some form of network.

During the earlier days, users are confined to exchanging textual contents. Nevertheless, human communication is only truly effective when verbal communication is coupled with non-verbal communication such as the tones of voices, facial expressions and body languages. In order to express their emotions simplistically, users then started using combinations of punctuation marks such as equals mark (=), semicolon mark (;), brackets and so forth and even alphabets and numbers to form text-based smileys in their instant messages to represent their facial expressions and/or emotions while communicating.

As instant messaging became increasingly popular, the stiff competition among technological experts and innovators in this field has led to the availability of instant messaging through more and more avenues, with innovative enhancements, in terms of interface, layout, functions and features, leaving the users spoilt for choices. Amongst the enhancements were graphical smileys, known as “emoticons” and a pre-packaged selection of emoticons from which the users may select to be used within the textual content and the auto generation of graphical smileys upon the keying in of certain common combination of punctuation marks, alphabets and numbers which form text-based smileys.

As the graphical capabilities of technological devices such as computers, laptops and especially mobile phones kept advancing, colourful smileys (now widely known as “emoticons”) replaced the plain graphical smileys, followed by larger “emoticons” or also known as “stickers” and the introduction of animated emoticons or stickers. Some instant messaging service providers have also enabled users to select from a list of emoticons and customise them to their own liking to better represent them or even to use avatars of themselves generated from photographs of each individual user.

Despite the enhancements to the ability of expression of a user's emotions, and mood via “emoticons” and “stickers”, some significant limitations to the ability of expression and reflection of emotions and mood of the user at the time of conveyance of his message via instant messaging remain.

Typically, aside from typing the message to be conveyed, the users would have to select the emoticons to be inserted within the textual content by clicking on an icon on the interface to open a selection of emotions from which they may select before clicking to select the emoticon of their choice or to click a pre-set button or type a certain common combination of punctuation marks, alphabets and numbers which form text-based smileys. It is only after these steps then the user may click “send” to transmit their message.

As for the more recent enhancements such as stickers and animated stickers, users would have to first send the textual content and thereafter send the stickers, as a separate message. This disassociates the emotions or mood by the stickers from the textual content, in that it no longer represents the reflection of the users' emotions or mood at the time of conveyance of messages.

The present invention is directed at overcoming or at least reducing one or more of the problems set forth above, enabling real time and more accurate representation and reflection of users' emotions and mood at the time of communication via instant messages more effectively, through a method of generating and presenting both the textual contents with graphical representation together as a whole and at the same time via instant messages in a simple minimised workflow.

### SUMMARY OF INVENTION

The present invention relates to a method and process of generation and presentation of textual contents with graphical representations via instant messages in a simple minimised workflow, thus enabling real time communication with more accurate expression of emotions and mood at the time of conveyance of the message. The user's selection of his choice of graphical representation after the typing of the textual contents, operates as the “send” button to initiate the transmission of the textual content and the selected graphical representation. Both the textual content as well as the graphical representation is received and displayed as a whole, to reflect the sender's emotions and mood at the time of the conveyance of the message. The instant message which comprises of the textual contents as well as the graphical representation is displayed together as a whole, in varying sizes depending on the length of the textual contents.

In one aspect of the present invention, a computer readable programme storage device is provided and encoded with instructions that, when executed on a processor of a device as an instant messaging communication application, performs a method. The method includes the user's selection of his choice of graphical representation after the typing of the textual contents, operating as the “send” button to initiate the transmission of the textual content and the selected graphical representation. Both the textual content as well as the graphical representation is received and displayed as a whole, to reflect the sender's emotions and mood at the time of the conveyance of the message. The instant message which comprises of the textual contents as well as the graphical representation is displayed together as a whole, in varying text font sizes depending on the length of the textual contents.

In still another aspect of the present invention, personalised graphical representations may be generated by first snapping a photograph of the user, detection of the user's facial features and generation of the graphical representation based on the detection results. Personalised graphical representations when used, uniquely identifies the user enabling an even more accurate expression of the user's emotions and mood at the time of communicating.

In yet another aspect of the present invention, even more personalised graphical representations may be generated with the inclusion of graphical representation customisation capabilities to enable the user to manually customise the personalised graphical representation.

In still another aspect of the present invention, animations may be applied to the personalised graphical representations generated by the graphical content personalisation and customisation processes to better express the user's emotions and mood.

In yet another aspect of the present invention, the personalised and/or customised graphical representations may be enhanced by capabilities to customise the backgrounds and/or text styles and/or include audio effects to selected graphical contents.

### DETAILED DESCRIPTION OF THE EMBODIMENTS

This present invention provides a method and process for generating and presenting textual contents with graphical representations such as emoticons and avatars used in instant messages together at the same time via instant messages in a simple minimised workflow. This enables the users to easily convey their message and express their emotions at the time of communication via instant messages more effectively as well as a more precise and accurate reflection of the users' emotions and moods at the time of communication via instant messages, rather than having to go through a more complicated multiple step work flow to convey their message and emotions.

For ease of understanding, the present invention will be primarily described in the context of wireless mobile devices with two participants in the instant messaging session. However, the present invention is not so limited. The present invention may also be practiced on other communication devices besides wireless mobile devices and may be readily employed in instant messaging sessions involving three or more participants.

FIG. 3A is a flow chart of the functioning of the present invention while FIG. 3B illustrates an example of the functioning of the present invention, where the selection of graphical representations operate to initiate the transmission of the textual content and the selected graphical representation. FIG. 4 may be referred to simultaneously with the discussion of FIG. 3A and B for a more complete understanding of the operation of the present invention.

One embodiment of the present invention is a method of generating and presenting textual contents with graphical representations such as emoticons and avatars. This entails typing the textual contents and then selecting the choice of graphical representation, which will then operate as the “send” button to initiate the transmission of the textual content and the selected graphical representation. This method also entails the receiving and displaying of both the textual content as well as the graphical representation together as a whole, to reflect the sender's emotions and mood at the time of the conveyance of the message. This method further entails the automatic adjustment of the font sizes of the textual contents according to the length of the textual content, for optimal reading.

In an alternative embodiment, a user, after typing the textual contents of his instant message, may just click the “send” button to initiate the transmission of the textual content to the recipient, as illustrated in FIG. 1 without having to include a graphical representation in his instant message just to transmit his instant message.

Another embodiment of the present invention is a computer readable programme storage device is provided and encoded with instructions that, when executed on a processor of a device as an instant messaging communication application is adapted to perform a method. The method includes the user's selection of his choice of graphical representation after the typing of the textual contents, operating as the “send” button to initiate the transmission of the textual content and the selected graphical representation. Both the textual content as well as the graphical representation are received and displayed as a whole, to reflect the sender's emotions and mood at the time of the conveyance of the message. The font sizes of the textual contents displayed is automatically adjusted according to the length of the textual content, for optimal reading.

In still another embodiment of the present invention are personalised graphical representation generation capabilities. This entails the generation of personalised graphical representation by first snapping a photograph of the user followed by the detection of the user's facial features and then generation of the graphical representation based on the detection results. Personalised graphical representations when used, uniquely identifies the user enabling an even more accurate expression of the user's emotions and mood at the time of communicating.

In yet another embodiment of the present invention is graphical representation customisation capabilities. This entails manual customisation of the personalised graphical representations by the users followed by the generation of the customised personalised graphical representation.

In still another embodiment of the present invention are animation application capabilities. This entails the application of selected animations to the personalised graphical representation generated by the graphical content personalisation and customisation processes to better express the user's emotions and mood.

In yet another embodiment of the present invention, the personalised and/or customised graphical representations may be enhanced by capabilities to customise the backgrounds and/or text styles and/or include audio effects to selected graphical contents.

The present invention has been described in terms of specific implementations and configurations which are intended to be exemplary only. The illustrative embodiments of the present inventions as described above do not describe all features of the actual implementation. Those skilled in the art, having read this disclosure will appreciate that numerous implementation-specific decision must be made in the development of an actual embodiment, many obvious variations, refinements and modifications may be made without departing from the inventive concept(s) disclosed herein.

### BRIEF DESCRIPTION OF THE DRAWINGS

The invention may be understood by reference to the following description and appended claims, when taken in conjunction with the accompanying drawings, in which:

FIGS. 1 A and B are flow charts illustrating the functioning of prior art instant messaging systems.

FIGS. 2 A and B illustrate the screen representations of the display of the textual and non-textual contents in a prior art instant messaging systems.

FIG. 3 A is a flow chart illustrating the functioning of the present invention, where the selection of graphical representations operate to initiate the transmission of the textual content and the selected graphical representation.

FIG. 3 B illustrates an example of the functioning of the present invention, where the selection of graphical representations operate to initiate the transmission of the textual content and the selected graphical representation.

FIG. 4 illustrates the screen representation of the display of the textual and non-textual contents of the present invention, where the textual content and the graphical representation are received and displayed as a whole at the same time, in varying text sizes depending on the length of the textual contents.

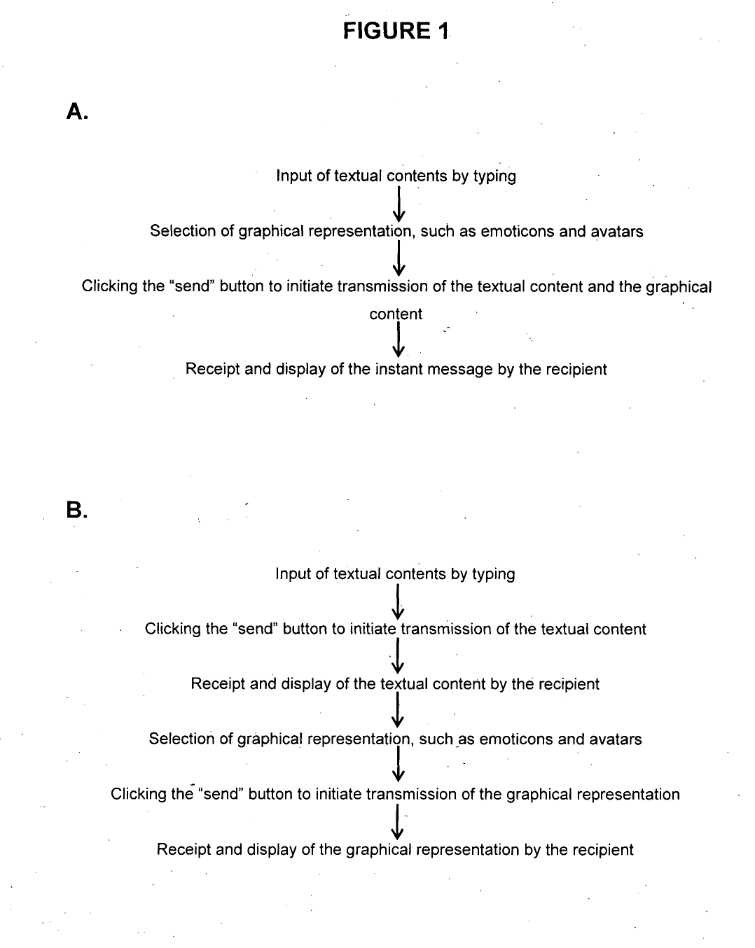

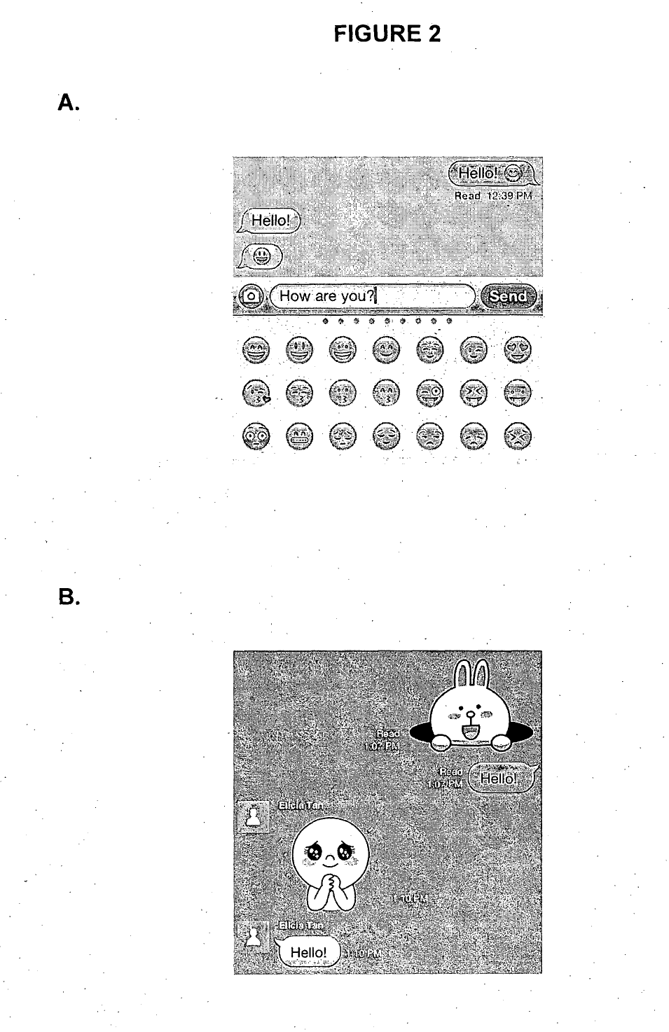

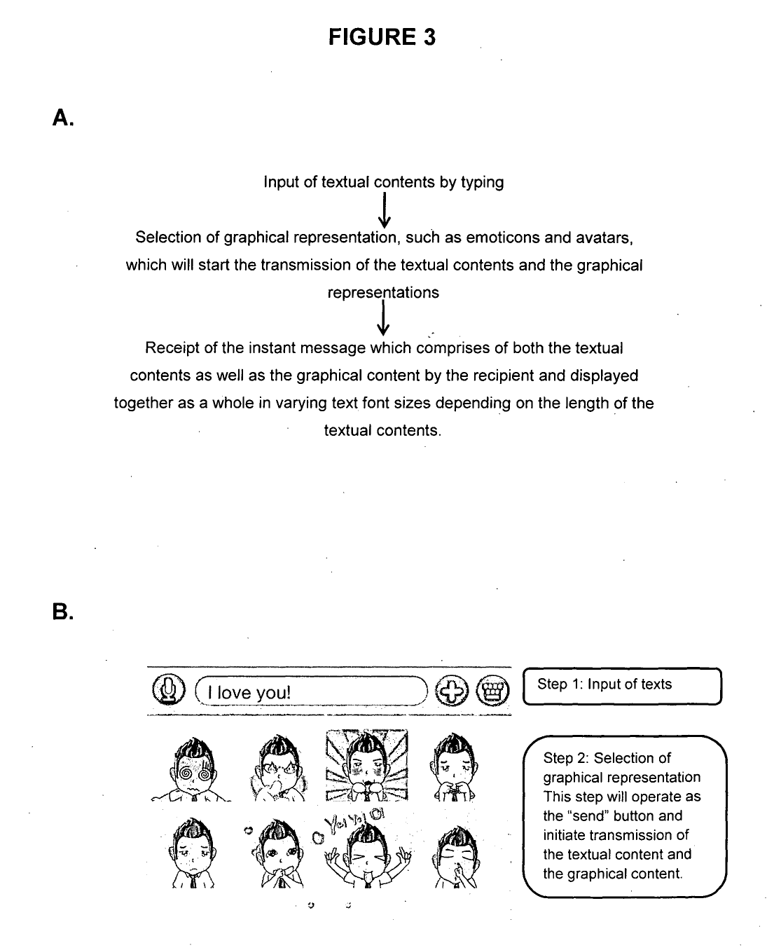

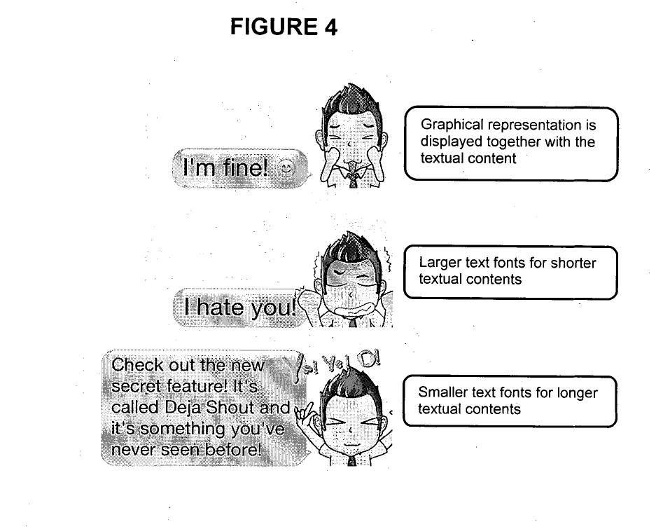

1. A method for monitoring a website for defacement comprising the steps of:
obtaining a baseline image of the website;
partitioning the baseline image into a plurality of baseline image regions according to a plurality of partitions in a partitioning algorithm;
allowing the partitions to be selected;
obtaining the selected partitions;
storing the baseline image regions which correspond to the selected partitions in a database;
obtaining an image instance of the website at a polled interval;
partitioning the image instance into a plurality of image instance regions according to the plurality of partitions in the partitioning algorithm;
extracting the image instance regions which correspond to the selected partitions;
performing image comparison on the stored baseline image regions and the extracted image instance regions; and
sending an alert that the website has been defaced when a result of the image comparison exceeds a first threshold.

2. The method of claim 1 wherein each stored baseline image regions and extracted image instance regions comprises pixels, each pixel having an image intensity value, and wherein the step of performing image comparison on the stored baseline image regions and the extracted image instance regions comprises the steps of:
calculating a first image intensity value for each of the stored baseline image regions by totaling up the image intensity values of the pixels;
calculating a second image intensity value for each of the extracted image instance regions by totaling up the image intensity values of the pixels; and
wherein the result of the image comparison is dependent on the difference between the first image intensity value and the second image intensity value.

3. The method of claim 1 wherein each stored baseline image regions and extracted image instance regions comprises pixels, each pixel having a red channel value, a green channel value and a blue channel value, and wherein the step of performing image comparison on the stored baseline image regions and the extracted image instance regions comprises the steps of:
calculating a first red channel value for each of the stored baseline image regions by totaling up the red channel values of each pixel;
calculating a second red channel value for each of the extracted image instance regions by totaling up the red channel values of each pixel;
calculating a first green channel value for each of the stored baseline image regions by totaling up the green channel values of each pixel;
calculating a second green channel value for each of the extracted image instance regions by totaling up the green channel values of each pixel;
calculating a first blue channel value for each of the stored baseline image regions by totaling up the blue channel values of each pixel;
calculating a second blue channel value for each of the extracted image instance regions by totaling up the blue channel values of each pixel; and
wherein the result of the image comparison is dependent on the difference between the first red channel value and the second red channel value, and on the difference between the first green channel value and the second green channel value, and on the difference between the first blue channel value and the second blue channel value.

4. The method of claim 1 wherein each stored baseline image regions and extracted image instance regions comprises pixels, each pixel having an image intensity value, a red channel value, a green channel value and a blue channel value, and wherein the step of performing image comparison on the stored baseline image regions and the extracted image instance regions comprises the steps of:
comparing the image intensity value of each pixel of the stored baseline image regions with the image intensity value of each pixel of the extracted image instance regions to determine a number of pixels whose image intensity value has changed;
comparing the red channel value of each pixel of the stored baseline image regions with the red channel value of each pixel of the extracted image instance regions to determine a number of pixels whose red channel value has changed;
comparing the green channel value of each pixel of the stored baseline image regions with the green channel value of each pixel of the extracted image instance regions to determine a number of pixels whose green channel value has changed;
comparing the blue channel value of each pixel of the stored baseline image regions with the blue channel value of each pixel of the extracted image instance regions to determine a number of pixels whose blue channel value has changed; and
wherein the result of the image comparison is dependent on the number of pixels whose image intensity value has changed, and on the number of pixels whose red channel value has changed, and on the number of pixels whose green channel value has changed and on the number of pixels whose blue channel value has changed.

5. The method of any one of the preceding claim& claim 1 further comprising the steps of:
obtaining a baseline HTML content of the website;
storing the baseline HTML content in the database;
obtaining a HTML content instance of the website at the polled interval;
performing content comparison on the stored baseline HTML content and the HTML content instance; and
sending an alert that the website has been defaced when a result of the content comparison exceeds a second threshold.

6. The method of claim 5 where the step of performing content comparison on the stored baseline HTML content and the HTML content instance comprises at least one of the steps of:
counting a number of links in the stored baseline HTML content and the HTML content instance;
counting a number of scripts in the stored baseline HTML content and the HTML content instance; and
counting a number of images in the stored baseline HTML content and the HTML content instance.

7. The method of claim 5 further comprising:
performing a first integrity comparison on the baseline image and the image instance;
performing a second integrity comparison on the baseline HTML content and the HTML content instance; and
sending an alert that the website has been defaced when a result of the first integrity comparison and a result of the second integrity comparison exceeds a third threshold.

8. The method of claim 7 wherein the step of performing a first integrity comparison on the baseline image and the image instance comprises the steps of:
hashing an image in the baseline image to obtain a first hash value;
hashing an image in the image instance to obtain the second hash value; and
comparing the first hash value and the second hash value.

9. The method of claim 7 wherein the step of performing a second integrity comparison on the baseline HTML content and the HTML content instance comprises the steps of:
hashing a script in the baseline HTML content to obtain a first hash value;
hashing a script in the HTML content instance to obtain the second hash value; and
comparing the first hash value and the second hash value.

10. The method of claim 5 further comprising the steps of checking the HTML content instance for malwares and sending an alert that the website has been defaced when at least one malware is detected.

11. The method of claim 5 further comprising the steps of:
waiting for a predetermined period to lapse after obtaining the baseline HTML content of the website;
obtaining another baseline HTML content of the website;
comparing the baseline HTML content with the another baseline HTML content and allowing the second threshold and third threshold to be adjusted based on this comparison.

12. The method of claim 1 wherein the partitioning algorithm is anyone of the following: a 4 by 4 grid; a 3 by 3 grid, a 5 by 5 grid and a 6 by 6 grid.

13. A system for monitoring a website for defacement comprising a database and at least one processor programmed to:
obtain a baseline image of the website;
partition the baseline image into a plurality of baseline image regions according to a plurality of partitions in a partitioning algorithm;
allow the partitions to be selected;
obtain the selected partitions;
store the baseline image regions which correspond to the selected partitions in the database;
obtain an image instance of the website at a polled interval;
partition the image instance into a plurality of image instance regions according to the partitions;
extract the image instance regions which correspond to the selected partitions;
perform image comparison on the stored baseline image regions and the extracted image instance regions; and
send an alert that the website has been defaced when a result of the image comparison exceeds a first threshold.

14. The system of claim 13 wherein each stored baseline image regions and extracted image instance regions comprises pixels, each pixel having an image intensity value, and wherein the at least one processor is further programmed to:
calculate a first image intensity value for each of the stored baseline image regions by totaling up the image intensity values of the pixels within each of the stored baseline image regions;
calculate a second image intensity value for each of the image instance regions by totaling up the image intensity values of the pixels within each of the extracted image instance regions; and
wherein the result of the image comparison is dependent on the difference between the first image intensity value and the second image intensity value.

15. The system of claim 13 wherein each stored baseline image regions and extracted image instance regions comprises pixels, each pixel having a red channel value, a green channel value and a blue channel value, and wherein the at least one processor is further programmed to:
calculate a first red channel value for each of the stored baseline image regions by totaling up the red channel values of each pixel within each of the stored baseline image regions;
calculate a second red channel value for each of the image instance regions by totaling up the red channel values of each pixel within each of the extracted image instance regions;
calculate a first green channel value for each of the stored baseline image regions by totaling up the green channel values of each pixel within each of the stored baseline image regions;
calculate a second green channel value for each of the image instance regions by totaling up the green channel values of each pixel within each of the extracted image instance regions;
calculate a first blue channel value for each of the stored baseline image regions by totaling up the red channel values of each pixel within each of the stored baseline image regions;
calculate a second blue channel value for each of the image instance regions by totaling up the red channel values of each pixel within each of the extracted image instance regions; and
wherein the result of the image comparison is dependent on the difference between the first red channel value and the second red channel value, and on the difference between the first green channel value and the second green channel value, and on the difference between the first blue channel value and the second blue channel value.

16. The system of claim 13 wherein each stored baseline image regions and extracted image instance regions comprises pixels, each pixel having an image intensity value, a red channel value, a green channel value and a blue channel value, and wherein the at least one processor is further programmed to:
compare the image intensity values of each pixel of the stored baseline image regions with the image intensity values of each pixel of the extracted image instance regions to determine a number of pixels whose image intensity values has changed;
compare the red channel values of each pixel of the stored baseline image regions with the image intensity values of each pixel of the extracted image instance regions to determine a number of pixels whose red channel values has changed;
compare the green channel values of each pixel of the stored baseline image regions with the image intensity values of each pixel of the extracted image instance regions to determine a number of pixels whose green channel values has changed;
compare the blue channel values of each pixel of the stored baseline image regions with the image intensity values of each pixel of the extracted image instance regions to determine a number of pixels whose blue channel values has changed; and
wherein the result of the image comparison is dependent on the number of pixels whose image intensity value has changed, and on the number of pixels whose red channel value has changed, and on the number of pixels whose green channel value has changed and on the number of pixels whose blue channel value has changed.

17. The system of claim 13 wherein the at least one processor is further programmed to:
obtain a baseline HTML content of the website;
store the baseline HTML content in the database;
obtain a HTML content instance of the website at the polled interval;
perform content comparison on the stored baseline HTML content and the HTML content instance; and
send an alert that the website has been defaced when a result of the content comparison exceeds a second threshold.

18. The system of claim 17 wherein the at least one processor is further programmed to:
count a number of links in the stored baseline HTML content and the HTML content instance;
count a number of scripts in the stored baseline HTML content and the HTML content instance; and
count a number of images in the stored baseline HTML content and the HTML content instance.

19. The system of claim 17 wherein the at least one processor is further programmed to:
perform a first integrity comparison on the baseline image and the image instance;
perform a second integrity comparison on the baseline HTML content and the HTML content instance; and
send an alert that the website has been defaced when a result of the first integrity comparison and a result of the second integrity comparison exceeds a third threshold.

20. The system of claim 19 wherein the at least one processor is further programmed to:
hash an image in the baseline image to obtain a first hash value;
hash an image in the image instance to obtain the second hash value; and
compare the first hash value and the second hash value.

21. The system of claim 19 wherein the at least one processor is further programmed to:
hash a script in the baseline HTML content to obtain a first hash value;
hash a script in the HTML content instance to obtain the second hash value; and
compare the first hash value and the second hash value.

22. The system of claim 17 wherein the at least one processor is further programmed to check the HTML content instance for malwares and send an alert that the website has been defaced when at least one malware is detected.

23. The system of claim 17 wherein the at least one processor is further programmed to:
wait for a predetermined period to lapse after obtaining the baseline HTML content of the website;
obtain another baseline HTML content of the website;
compare the baseline HTML content with the another baseline HTML content and allow the second threshold and third threshold to be adjusted based on this comparison.

24. The system of claim 13 wherein the partitioning algorithm is anyone of the following: a 4 by 4 grid; a 3 by 3 grid, a 5 by 5 grid and a 6 by 6 grid.
